(19) United States
(12) Patent Application Publication
(10) Pub. No.: US 2023/0059205 A1
(43) Pub. Date: Feb. 23, 2023

(54) SYSTEM AND METHOD FOR CARGO TRANSPORTATION MANAGEMENT

(71) Applicant: SAMSON LOGIC TRANSPORTATION LTD., Ramat Hasharon (IL)

(72) Inventors: Shai PRUPES, Ramat HaSharon (IL); Dmitri (Danny) VAINER, Haifa (IL)

(73) Assignee: SAMSON LOGIC TRANSPORTATION LTD., ramat Hasharon (IL)

(21) Appl. No.: 17/797,532

(22) PCT Filed: Feb. 3, 2021
(86) PCT No.: PCT/IL2021/050131

§ 371 Date: Aug. 4, 2022

Related U.S. Application Data
(60) Provisional application No. 62/970,065, filed on Feb. 4, 2020.

(51) Int. Cl. G06Q 50/28; G06Q 10/06; B65D 90/48; B65D 88/00; B65G 1/04

(52) U.S. Cl. CPC G06Q 50/28; G06Q 10/06315; B65D 90/48; B65D 88/005; B65G 1/0442; G06Q 10/0833

(57) ABSTRACT

Systems and methods for cargo transportation management, including: a database, to store structure information for a plurality of containers; and a processor, in communication with the database, where the processor is configured to: receive cargo information, generate a container distribution plan, for distributing the cargo between the plurality of containers based on the structure information and based the received cargo information, and send the generated container distribution plan for packaging of the cargo, where each container includes a plurality of walls, at least one connector, configured to securely connect to another container; and at least one sensor, configured to monitor movement of the container and monitor movement of the cargo within the container, where at least one wall has changeable size.

### FIELD OF THE INVENTION

The present invention relates to cargo transportation. More particularly, the present invention relates to systems and methods for cargo transportation management using a plurality of smart containers.

### BACKGROUND OF THE INVENTION

Transportation of cargo, for instance transportation of construction material such as reinforcement bars (or rebars) to construction sites, has substantially remained unchanged for decades while many technological advancements have become available. Cargo is loaded, for example by a truck, and transported to a destination for unloading of the cargo, e.g., by a crane or a forklift.

The cargo can include various materials, but when packed at a factory, warehouse, port, etc., the cargo is usually quickly packaged for transportation, without any optimization of the packaging. Thus, the cargo can arrive to the destination in varying size of packages and can require a large number of transports if not optimally packaged, as well as increased time for loading and unloading of the cargo as the unloading of the cargo is not associated with crane capacity.

For example, in case of lack of coordination between the cargo packaging (e.g., at a factory) and the destination (e.g., at a port or assembly line), too much or too little material arrives at the destination, sometimes causing to waste of material on site, due to non-consistent packaging, excess of material, improper lifting, or improper storage during transportation or storage at destination site.

Additional problems with cargo packaging can arise when a special sized material is transported and cannot be traced, particularly for materials that are lifted by a forklift or crane such as at a construction site, a warehouse, or a port.

For example, if the cargo material is rebar that is used mainly in construction sites, the packaging can be typically carried out by simply tying a bunch of rebar together and loading onto a truck. A rebar may include a steel bar or mesh of steel wires used as a tension device in reinforced concrete and reinforced masonry structures to strengthen and aid the concrete under tension. From the truck, the bunch of rebar is lifted by a crane to the destination. Since the bunches of rebar have varying sizes, weights, etc., the crane operator can waste working time on multiple rounds of unloading the truck.

### SUMMARY

There is thus provided in accordance with some embodiments of the invention, a system for cargo transportation management, the system including: a database, to store structure information for a plurality of containers, and a processor, in communication with the database, where the processor is configured to: receive cargo information, including at least one of: cargo size, cargo shape, type of material, and cargo assembly order, generate a container distribution plan, for distributing the cargo between the plurality of containers based on the structure information and based the received cargo information, and send the generated container distribution plan for packaging of the cargo.

In some embodiments, the structure information includes at least one of: capacity, weight, size, shape, center of mass, maximum transportation weight, maximum transportation size, and maximum lifting capacity of a lifting device. In some embodiments, the plurality of containers includes modular containers of different sizes. In some embodiments, the size of at least one container is changeable in accordance with the container distribution plan. In some embodiments, at least one container of the plurality of containers includes a sensor to monitor the movement of that container.

In some embodiments, the sensor is selected from a group consisting of: Internet of Things (IoT) sensor, GPS, GNSS, cameras, proximity sensors, weight sensors, accelerometer, gyroscope, barometer, wireless communication module, temperature sensor, and light sensor. In some embodiments, the sensor is configured to monitor the cargo. In some embodiments, the sensor is in communication with a transport device that is moving the plurality of containers. In some embodiments, the processor is configured to use input from the sensor in order to optimize location of the plurality of containers adjacent to the transport device. In some embodiments, the sensor is in communication with a central communication unit.

In some embodiments, the generated container distribution plan for packaging of the cargo includes instructions to assemble the containers with the cargo for transport. In some embodiments, each container of the plurality of containers is configured to securely lock to at least one other container, at least for the duration of transportation.

There is thus provided in accordance with some embodiments of the invention, a method of managing cargo transportation for a plurality of containers, including: receiving, by a processor, cargo information including at least one of: cargo size, cargo shape, type of material, and cargo assembly order, generating, by the processor, a container distribution plan, for distributing the cargo between the plurality of containers based on the received cargo information and based on structure information of plurality of containers, and sending the generated container distribution plan for packaging of the cargo.

In some embodiments, the structure information includes at least one of: capacity, weight, size, shape, center of mass, maximum transportation weight, maximum transportation size, and maximum lifting capacity by a lifting device. In some embodiments, the plurality of containers is arranged as modular containers of different sizes. In some embodiments, the size of at least one container is changed in accordance with the container distribution plan. In some embodiments, movement of each container of the plurality of containers is monitored with a sensor. In some embodiments, the sensor is selected from a group consisting of: Internet of Things (IoT) sensor, GPS, GNSS, cameras, proximity sensors, weight sensors, accelerometer, gyroscope, barometer, wireless communication module, temperature sensor, and light sensor. In some embodiments, the cargo is monitored with the sensor. In some embodiments, the sensor is in communication with a transport device that is moving the plurality of containers.

In some embodiments, the processor is configured to use input from the sensor in order to optimize location of the plurality of containers adjacent to the transport device. In some embodiments, the sensor is in communication with a central communication unit. In some embodiments, the generated container distribution plan for packaging of the cargo includes instructions to assemble the containers with the cargo for transport. In some embodiments, each container of the plurality of containers is configured to securely lock to at least one other container, at least for the duration of transportation.

There is thus provided in accordance with some embodiments of the invention, a container for cargo transportation, including: a plurality of walls, where at least one wall is configured to allow insertion of cargo into the container, at least one connector, configured to securely connect to another container, and at least one sensor, configured to monitor movement of the container and monitor movement of the cargo within the container. In some embodiments, at least one wall has changeable size.

In some embodiments, the plurality of walls is modular, and where at least one wall interchangeable with another wall type. In some embodiments, where the at least one connector includes at least one track. In some embodiments, the at least one sensor is selected from a group consisting of: Internet of Things (IoT) sensor, GPS, GNSS, cameras, proximity sensors, weight sensors, accelerometer, gyroscope, barometer, wireless communication module, temperature sensor, and light sensor.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 shows a block diagram of an exemplary computing device, according to some embodiments of the invention;

FIG. 2 shows a block diagram of a system for cargo transportation management, according to some embodiments of the invention;

FIG. 3A illustrates a first configuration of a smart container for cargo transportation, according to some embodiments of the invention;

FIG. 3B illustrates a second configuration of a smart container for cargo transportation, according to some embodiments of the invention;

FIG. 3C illustrates a third configuration of a smart container for cargo transportation, according to some embodiments of the invention;

FIG. 3D illustrates a fourth configuration of a smart container for cargo transportation, according to some embodiments of the invention;

FIG. 4A illustrates a configuration of assembling the containers for cargo transportation, according to some embodiments of the invention;

FIG. 4B illustrates another configuration of assembling the containers for cargo transportation, according to some embodiments of the invention;

FIG. 5 illustrates an outrigger scaffolding to support the container, according to some embodiments of the invention; and

FIG. 6 shows a flowchart of a method of managing cargo transportation for a plurality of containers, according to some embodiments of the invention.

It will be appreciated that, for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components, modules, units and/or circuits have not been described in detail so as not to obscure the invention. Some features or elements described with respect to one embodiment may be combined with features or elements described with respect to other embodiments. For the sake of clarity, discussion of same or similar features or elements may not be repeated.

Although embodiments of the invention are not limited in this regard, discussions utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes.

Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. The term set when used herein may include one or more items.

Unless explicitly stated, the method embodiments described herein are not constrained to a particular order or sequence. Additionally, some of the described method embodiments or elements thereof can occur or be performed simultaneously, at the same point in time, or concurrently.

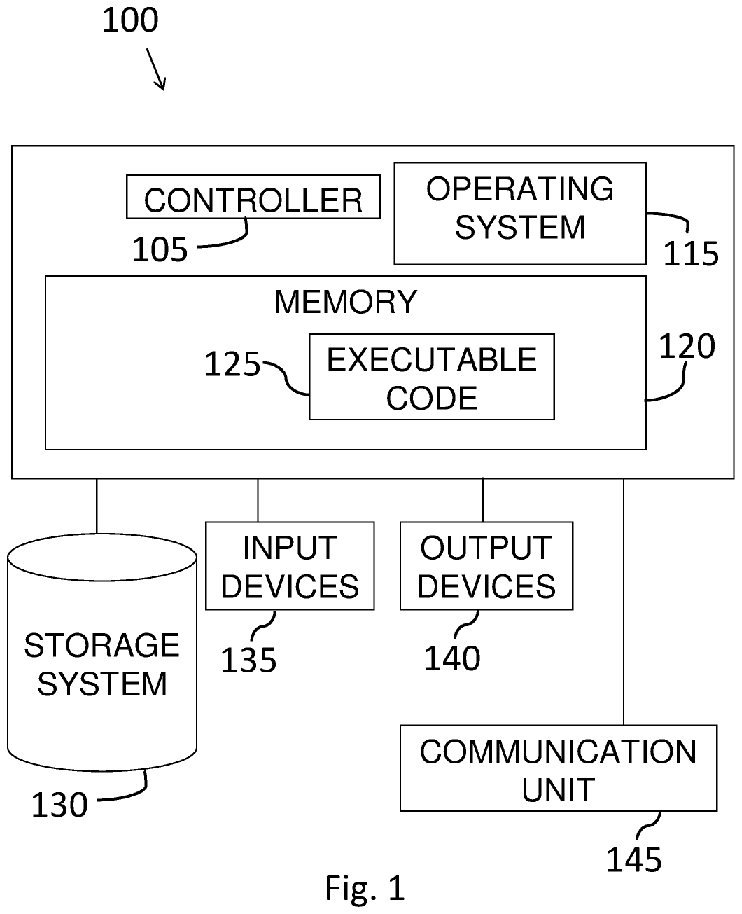

Reference is made to FIG. 1, which is a schematic block diagram of an example computing device 100, according to some embodiments of the invention. Computing device 100 may include a controller or processor 105 (e.g., a central processing unit processor (CPU), a programmable controller or any suitable computing or computational device), memory 120, storage 130, input devices 135 (e.g. a keyboard or touchscreen), and output devices 140 (e.g., a display), a communication unit 145 (e.g., a cellular transmitter or modem, a Wi-Fi communication unit, or the like) for communicating with remote devices via a computer communication network, such as, for example, the Internet.

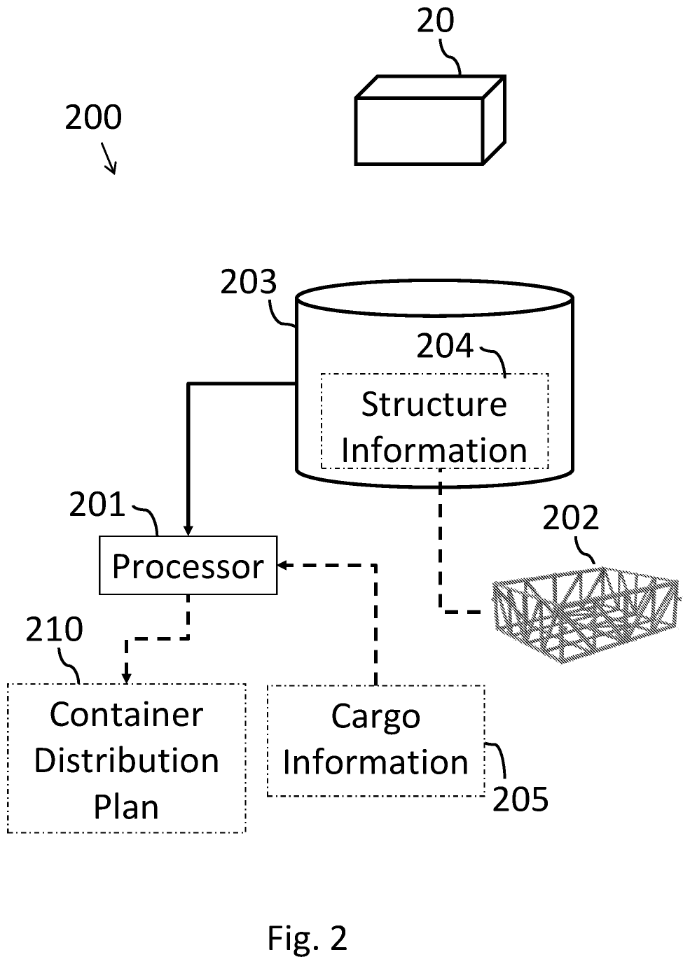

The computing device 100 may operate by executing an operating system 115 and/or executable code 125. Controller 105 may be configured to execute program code to perform operations described herein. The system described herein may include one or more computing devices 100, for example, to act as the various devices or the components shown in FIG. 2. For example, system 200 may be, or may include computing device 100 or components thereof.

Operating system 115 may be or may include any code segment or one or more code sets (e.g., one similar to executable code 125 described herein) designed and/or configured to perform tasks involving coordinating, scheduling, arbitrating, supervising, controlling or otherwise managing operation of computing device 100, for example, scheduling execution of software programs or enabling software programs or other modules or units to communicate.

Memory 120 may be or may include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units.

Memory 120 may be or may include a plurality of, possibly different memory units. Memory 120 may be a computer or processor non-transitory readable medium, or a computer non-transitory storage medium, e.g., a RAM.

Executable code 125 may be any executable code, e.g., an application, a program, a process, task or script. Executable code 125 may be executed by controller 105 possibly under control of operating system 115. For example, executable code 125 may be a software application that performs methods as further described herein.

Although, for the sake of clarity, a single item of executable code 125 is shown in FIG. 1, a system according to some embodiments of the invention may include a plurality of executable code segments similar to executable code 125 that may be stored into memory 120 and cause controller 105 to carry out methods described herein.

Storage 130 may be or may include, for example, a hard disk drive, a universal serial bus (USB) device or other suitable removable and/or fixed storage unit. In some embodiments, some of the components shown in FIG. 1 may be omitted. For example, memory 120 may be a non-volatile memory having the storage capacity of storage 130. Accordingly, although shown as a separate component, storage 130 may be embedded or included in memory 120.

Input devices 135 may be or may include a keyboard, a touch screen or pad, one or more sensors or any other or additional suitable input device. Any suitable number of input devices 135 may be operatively connected to computing device 100. Output devices 140 may include one or more displays or monitors and/or any other suitable output devices. Any suitable number of output devices 140 may be operatively connected to computing device 100. Any applicable input/output (I/O) devices may be connected to computing device 100 as shown by blocks 135 and 140. For example, a wired or wireless network interface card (MC), a universal serial bus (USB) device or external hard drive may be included in input devices 135 and/or output devices 140.

Some embodiments of the invention may include an article such as a computer or processor non-transitory readable medium, or a computer or processor non-transitory storage medium, such as for example a memory, a disk drive, or a USB flash memory, encoding, including or storing instructions, e.g., computer-executable instructions, which, when executed by a processor or controller, carry out methods disclosed herein.

For example, an article may include a storage medium such as memory 120, computer-executable instructions such as executable code 125 and a controller such as controller 105. Such a non-transitory computer readable medium may be, for example, a memory, a disk drive, or a USB flash memory, encoding, including or storing instructions, e.g., computer-executable instructions, which, when executed by a processor or controller, carry out methods disclosed herein.

The storage medium may include, but is not limited to, any type of disk including, semiconductor devices such as read-only memories (ROMs) and/or random-access memories (RAMs), flash memories, electrically erasable programmable read-only memories (EEPROMs) or any type of media suitable for storing electronic instructions, including programmable storage devices. For example, in some embodiments, memory 120 is a non-transitory machine-readable medium.

A system according to some embodiments of the invention may include components such as, but not limited to, a plurality of central processing units (CPU) or any other suitable multi-purpose or specific processors or controllers (e.g., controllers similar to controller 105), a plurality of input units, a plurality of output units, a plurality of memory units, and a plurality of storage units.

A system may additionally include other suitable hardware components and/or software components. In some embodiments, a system may include or may be, for example, a personal computer, a desktop computer, a laptop computer, a workstation, a server computer, a network device, or any other suitable computing device. For example, a system as described herein may include one or more facility computing device 100 and one or more remote server computers in active communication with one or more facility computing device 100 such as computing device 100, and in active communication with one or more portable or mobile devices such as smartphones, tablets and the like.

Reference is now made to FIG. 2, which shows a block diagram of a system 200 for cargo transportation management, according to some embodiments. In FIG. 2, hardware elements are indicated with a solid line and the direction of arrows may indicate the direction of information flow.

The system 200 may include a processor 201 (e.g., such as controller 105 shown in FIG. 1) configured to analyze cargo 20 data (e.g., type of cargo 20, weight, etc.), as well as cargo transportation information (e.g., type of lifting device to lift the cargo), in order to generate a container distribution plan 210 for packaging the cargo 20 within a plurality of containers 202.

It should be noted that while a single container 202 is shown in FIG. 2, the system 200 may similarly apply to a plurality of containers 202.

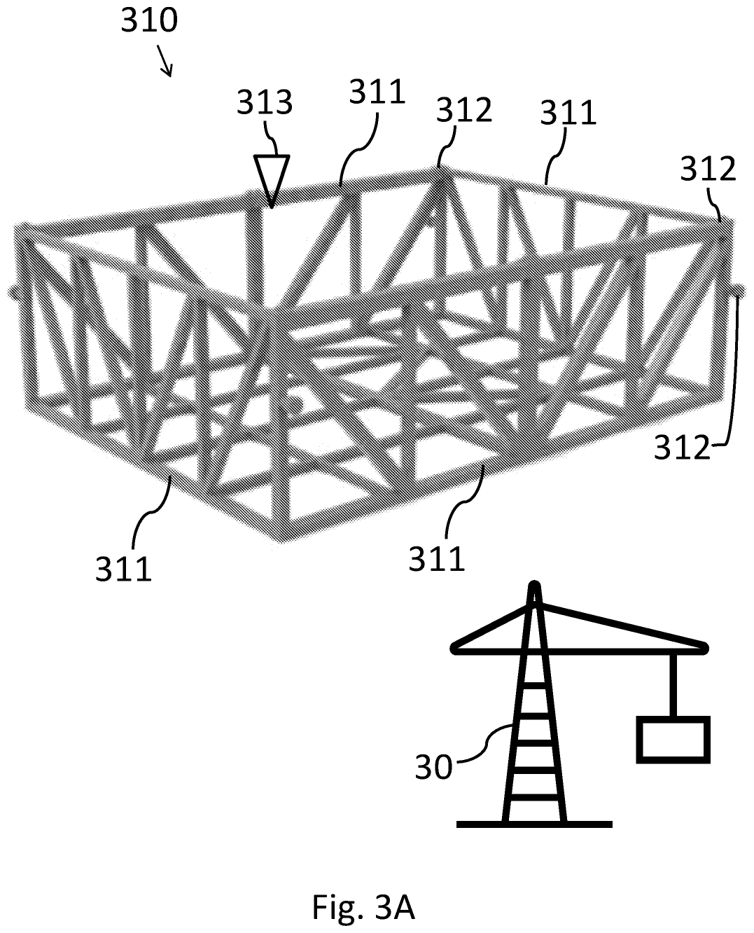

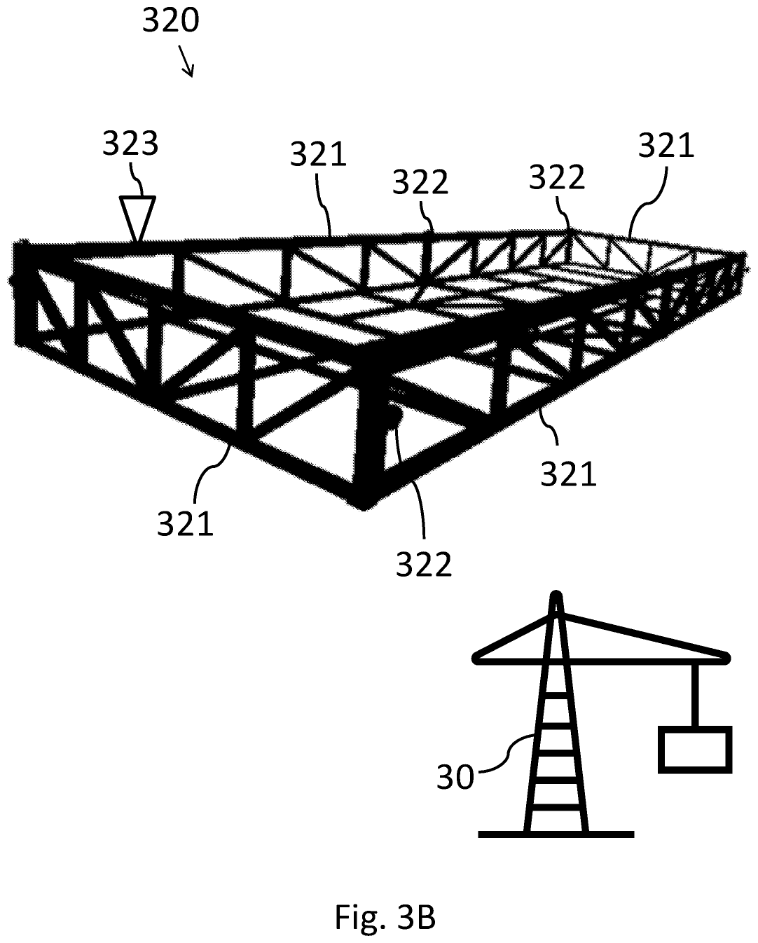

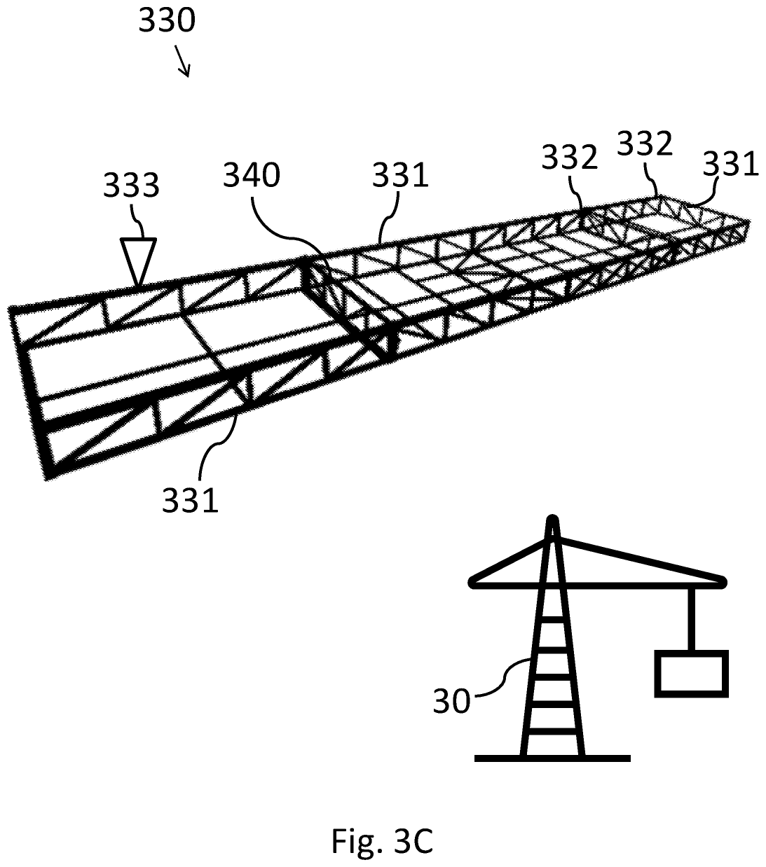

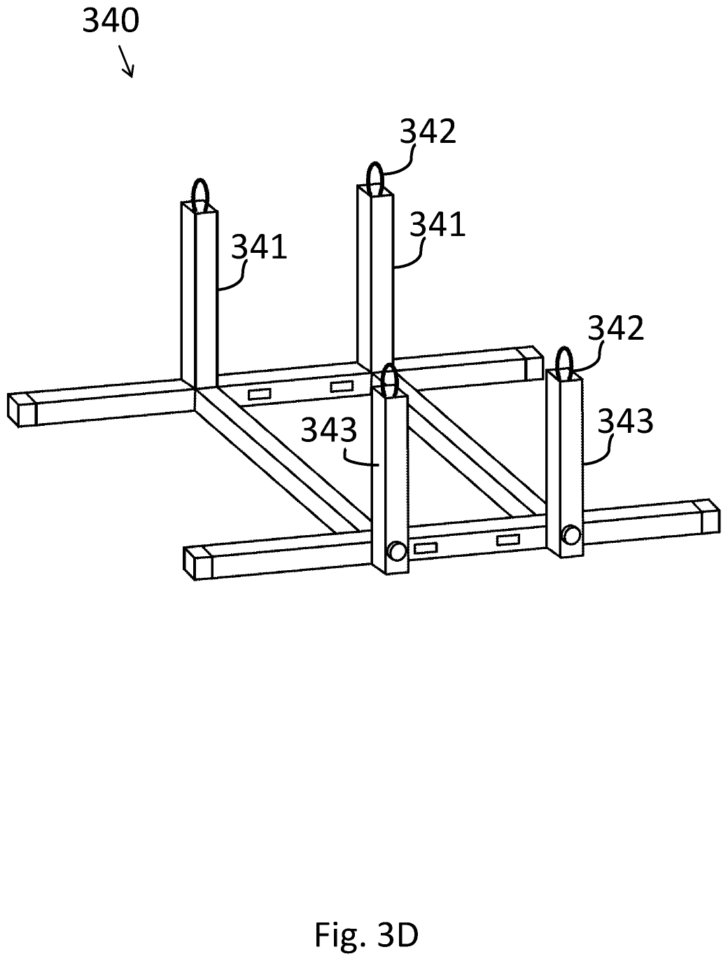

According to some embodiments, the plurality of containers 202 includes smart containers of various shapes and/or sizes (e.g., modular containers), as further described in FIGS. 3A-3D.

In some embodiments, the processor 201 is coupled to, and/or in communication with, a database 203 (e.g., such as storage system 130 shown in FIG. 1) that stores structure information 204 for the plurality of containers 202.

The structure information 204 may include structural information of the plurality of containers 202, such as the capacity, weight, size, shape, center of mass, maximum transportation weight, maximum transportation size, and maximum lifting capacity of a lifting device (e.g., crane, forklift, etc.).

In some embodiments, the processor 201 is configured to receive cargo information 205 (e.g., received from a factory that packages the cargo 20, or received from the cargo destination site). In some embodiments, the cargo information 205 is received by a dedicated software for cargo ordering or management (e.g., using Building Information Modeling (BIM) software).

The cargo information 205 may include at least one of: cargo size, cargo shape, type of material, and cargo assembly order. For example, the cargo assembly order may modify cargo packaging such that cargo material used first at the destination site may be packaged at the top of a container 202, while cargo material used last at the destination site may be packaged at the bottom of a container 202. In another example, the cargo assembly order may modify the order of assembling containers on top of each other, such that the top container may include the cargo to be used first, while the bottom container may include the cargo to be used last. Other factors that influence the cargo assembly order may include working location at the destination site (e.g., some cargo may be required at a different location), required cargo storage conditions (e.g., storage at a predefined temperature and/or humidity), and restrictions on storage with a mixture of materials (e.g., for chemically reactive materials).

In some embodiments, the processor 201 is configured to generate the container distribution plan 210, for distributing the cargo 20 between the plurality of containers 20 based on the structure information 204 and based the received cargo information 205. In some embodiments, the container distribution plan 210 is further based on information related to transportation device (e.g., type of device to transport the container and/or lifting capacity). Accordingly, the processor 201 may be configured to send the generated container distribution plan 210 for packaging of the cargo 20.

In some embodiments, the processor 201 is configured to generate the container distribution plan 210 according to local standards and/or regulations related to handling the cargo 20. For example, if the cargo 20 requires cooling during transport, or if the cargo 20 is required to be transported with a dedicated weight limitation. In another example, the container distribution plan 210 may be limited by maximal weight and/or height of a stack of containers 202, during transport or at the destination site.

In some embodiments, the processor 201 is configured to generate the container distribution plan 210 for optimization of cargo transportation according to a dedicated machine learning algorithm that is trained on cargo packaging data. For example, the processor 201 may analyze data on container location during transportation and/or at the destination site, as well as information on cargo 20 usage, in order to generate at least one recommendation for the container distribution plan 210, such as preferred location of the container 202 and/or preferred storage conditions for a particular cargo 20.

In some embodiments, the generated container distribution plan 210 may be sent (e.g., by the processor 201) to a factory that manufactures the cargo material for packaging the cargo 20 on site with the plurality of containers 202 based on the container distribution plan 210.

For example, in the case of cargo 20 of construction material, reinforcement bars (or rebars) are widely used and commonly stored at every construction site. Thus, the cargo information 205 may include characteristics the rebar, such as diameter, weight, etc. Additionally, the cargo information 205 may include assembly order for the rebar at the construction site, where rebars of a first diameter or weight are used at the beginning of constructions, while rebars of a second diameter or weight are used lastly.

The processor 201 may receive the cargo information 205 from the factory manufacturing the rebar, and analyze the cargo information 205 together with structure information 204. In some embodiments, the processor 201 executes a dedicated algorithm for cargo 20 specifications, including input details for cargo 20 type, size, shape, etc.

The structure information 204 may include container 202 size and/or shape, such that the processor 201 may execute a dedicated algorithm to optimize packaging of the cargo 20 (e.g., rebar) within the plurality of containers 202 based on the structure information 204. For example, packaging of rebar into the plurality of containers 202 may be based on order of assembly according to the container distribution plan 210 generated by the processor 201.

Once the rebar cargo 20 is packaged into the plurality of containers 202, and transported (e.g., by a truck) to the destination site (e.g., a construction site), the cargo 20 may be unloaded (e.g., by a crane, forklift, etc.) based on the order of assembly according to the container distribution plan 210.

In some embodiments, the generated container distribution plan 210 for packaging of the cargo 20 may include instructions to assemble the plurality of containers 202 with the cargo 20 for transport. In some embodiments, the generated container distribution plan 210 for packaging of the cargo 20 may include instructions to assemble the plurality of containers 202 with the cargo 20 (e.g., assembling containers 202 on top of each other or side by side) at the destination site. For example, assembling the containers 202 based on a predefined order where the top container 202 may include the cargo 20 that needs to be used first.

In some embodiments, the cargo information further includes information for transporting the cargo, such as destination site type, destination site size, destination site access to vehicles, destination site location, transportation device type, transportation device capacity, etc.

Reference is now made to FIGS. 3A-3C, which illustrate several configurations of the smart container 202 (as shown in FIG. 2) for cargo transportation, according to some embodiments. In some embodiments, the plurality of containers 202 includes modular containers of different sizes.

For example, the smart container 202 may include materials such as steel and/or plastic.

FIG. 3A illustrates a first configuration 310 of a smart container, for instance having a length of three meters (e.g., capable of carrying a weight of 4 tons). FIG. 3B illustrates a second configuration 320 of a smart container, for instance having a length of six meters. FIG. 3C illustrates a third configuration 330 of a smart container, for instance having a length of twelve meters.

According to some embodiments, each smart container includes a plurality of walls 311, 321, 331. For each smart container, at least one wall of the plurality of walls 311, 321, 331 may be configured to allow insertion of cargo 20 into the container. For example, the container may be cube shaped and include five walls, such that the sixth side of the cube remains open for insertion of the cargo 20.

In some embodiments, at least one wall of the plurality of walls 311, 321, 333 includes an opening (e.g., a window or aperture) to allow insertion of cargo 20 into the container.

In some embodiments, at least one wall of the plurality of walls 311, 321, 333 is movable to allow insertion of cargo 20 into the container, for example a moving wall similar to a lid of a box, or a sliding window.

According to some embodiments, at least one wall of the plurality of walls 311, 321, 333 has changeable size. For example, at least a portion of one wall may be folded (or reduced in size) in case that the cargo 20 does not occupy the entire volume of that container.

In some embodiments, the size of at least one container 202 is changeable in accordance with the container distribution plan 210 (e.g., as shown in FIG. 2). For example, in case that the container distribution plan 210 requires a container of the second configuration 320 (as shown in FIG. 3B), and at the cargo packaging site there is only a container of the third configuration 330 (as shown in FIG. 3B), at least one wall of that container may be moved (e.g., along a track as in telescopic boxes) to change the size of the entire container.

In some embodiments, the container includes a barrier wall 340 as shown in FIG. 3C, in order to keep apart different types of cargo 20 within that container and/or in order to increase the security of the cargo 20 during transportation.

According to some embodiments, the plurality of walls 311, 321, 333 are modular in size and/or shape. Thus, at least one wall of the plurality of walls 311, 321, 333 may be interchangeable or interlocking with another wall type. Accordingly, a variety of container types may be created by assembling different wall types together (e.g., similarly to assembling of different building blocks).

For example, a wall 321 may be removed from a container, to be replaced by another wall type such as a window, a door, railings, a ladder, a ramp, a wall with built-in shelfs, a moving wall with built-in wheels, etc. In another example, some wall types may be added to the container such as barrier walls 340.

In some embodiments, connections between different walls and/or between different containers, are achieved by at least one of the following: mechanical connection, twist lock connection, electrical connection, pneumatic connection, hydraulic connection, or manual connection. For example, the connection may be to the base of a container.

According to some embodiments, each smart container includes at least one connector 312, 322, 332, configured to securely connect to another container. Accordingly, each container may securely lock to at least one other container, at least for the duration of transportation of the cargo 20 (e.g., on a truck or on a cargo ship).

In some embodiments, at least one connector 312, 322, 332 includes at least one track, such that the container moves along the track to connect to another container. For example, at least one connector 312, 322, 332 may include a wheel for moving the container onto another container and/or onto a transportation vehicle (e.g., a truck). Using such wheels, it may be possible to pull the container (e.g., along a track) and thereby reduce the required force for lifting the container (e.g., by a crane).

In some embodiments, using the at least one connector 312, 322, 332 may enhance safety of transport (e.g., by a crane) since the cargo may be securely transported when the transporting device 30 (e.g., a crane or forklift) moves the cargo via the at least one connector 312, 322, 332, rather than randomly connecting a crane hook to the cargo.

According to some embodiments, the container is assembled from a plurality of modular walls. For example, a twelve meter wall may be assembled from four three meter wall portions. Accordingly, transportation of such modular walls may be improved since the same volume may be optimally occupied with smaller size walls.

In some embodiments, the container distribution plan 210 (as shown in FIG. 210) is also based on transporting device 30 data. For example, the container distribution plan 210 may be based on the type of the transporting device 30 (e.g., a crane or forklift), and/or based on maximum lifting capacity of the transporting device 30.

According to some embodiments, each smart container includes at least one sensor 313, 323, 333 to monitor the movement of that container. For example, the at least one sensor 313, 323, 333 may monitor movement of the container (e.g., monitoring inclination angle or shock to the container) during loading and/or during unloading of the cargo 20 to ensure safety of the cargo 20 as well as safety of the container.

In another example, the at least one sensor 313, 323, 333 may monitor movement of the container when lifted by a transport device 30 (e.g., a crane or a forklift).

In some embodiments, the processor uses input from the at least one sensor 313, 323, 333 monitoring movement of the container to calculate the center of mass of the container with the cargo 20 during transport in order to identify extreme changes in the center of mass so as to prevent accidents.

The at least one sensor 313, 323, 333 may also be configured to monitor the cargo 20 within the container. For example, the at least one sensor 313, 323, 333 may monitor the temperature of the cargo 20 when a particular temperature is required for securely transporting the cargo 20.

In another example, the at least one sensor 313, 323, 333 may monitor movement of the cargo 20 within the container to prevent damage to the cargo 20.

In some embodiments, the at least one sensor 313, 323, 333 is at least one of: an Internet of Things (IoT) sensor, a Global Positioning System (GPS), a Global Navigation Satellite System (GNSS), a camera, proximity sensor, a weight sensor, an accelerometer, a gyroscope, a barometer, a wireless communication module, a temperature sensor, a humidity sensor and a light sensor.

In some embodiments, the at least one sensor 313, 323, 333 is used to determine the location of the container. For example, the at least one sensor 313, 323, 333 may be a sensor using at least one of: Bluetooth Low Energy (BLE), communication via Infra-Red or the Ultra-Wide band, Real-Time Kinematic (RTK) positioning, Global Positioning System (GPS), a Global Navigation Satellite System (GNSS), and Inertial Navigation System (INS).

In some embodiments, the sensor 313, 323, 333 is in communication with a transport device 30 that is moving the plurality of containers. The transport device 30 may be a truck, a crane, a forklift, etc.

For example, the sensor 313, 323, 333 may communicate with the transport device 30 in order to notify the transport device 30 the location of the container for transport among the plurality of containers. In another example, the sensor 313, 323, 333 may communicate with the transport device 30 in order to alert the transport device 30 when the monitored movement of the container and/or movement of the cargo exceeds a predefined threshold (e.g., detecting too steep inclination angle during transport).

In some embodiments, the processor is configured to use input from the sensor 313, 323, 333 in order to optimize location of container adjacent to the transport device 30 (e.g., truck, cargo ship, crane, forklift, etc.).

In some embodiments, the at least one sensor 313, 323, 333 is used to pair or assign a cargo 20 to the appropriate container using cameras. For example, using a Quick Response (QR) code camera, Near-Field communication or Radio-Frequency Identification (RFID) to identify the cargo and/or the container such that the right cargo 20 is inserted into the right container.

In some embodiments, the at least one sensor 313, 323, 333 is used to initiate operation of alerting systems during movement of the container. For example, when the at least one sensor 313, 323, 333 identified movement of the container, at least one light and/or horn (on the container and/or on the transport device and/or in their surroundings) may be activated in the vicinity of the moving container so as to prevent people getting near the moving container.

In some embodiments, the at least one sensor 313, 323, 333 is in communication with a central communication unit (e.g., located at a construction site or a distribution center). Utilizing such communication with a central communication unit, it may be possible to save battery power, since there is no need for each sensor to constantly communicate all monitored data (e.g., via cellular communication).

Reference is now made to FIG. 3D, which illustrates a fourth configuration 340 of the smart container for cargo transportation, according to some embodiments.

In some embodiments, the fourth configuration 340 of the smart container (e.g., size of six meters) is used for transportation of steel grids. A first portion 341 of the fourth configuration 340 may be fixed, while a second portion 343 of the fourth configuration 340 may move (e.g., folded), in order to allow insertion of the steel grid.

The fourth configuration 340 of the smart container may be connected to another smart container using connectors 342 (e.g., twist lock connectors) such as the at least one connector 312, 322, 332 shown in FIGS. 3A-3C. For example, the fourth configuration 340 of the smart container may be connected to the top of a container stack.

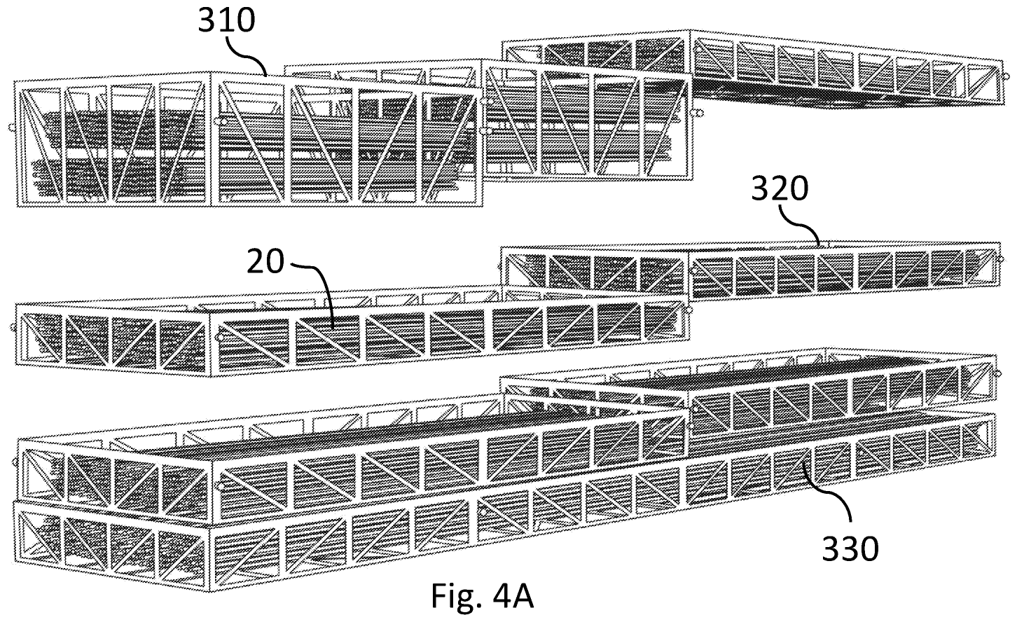

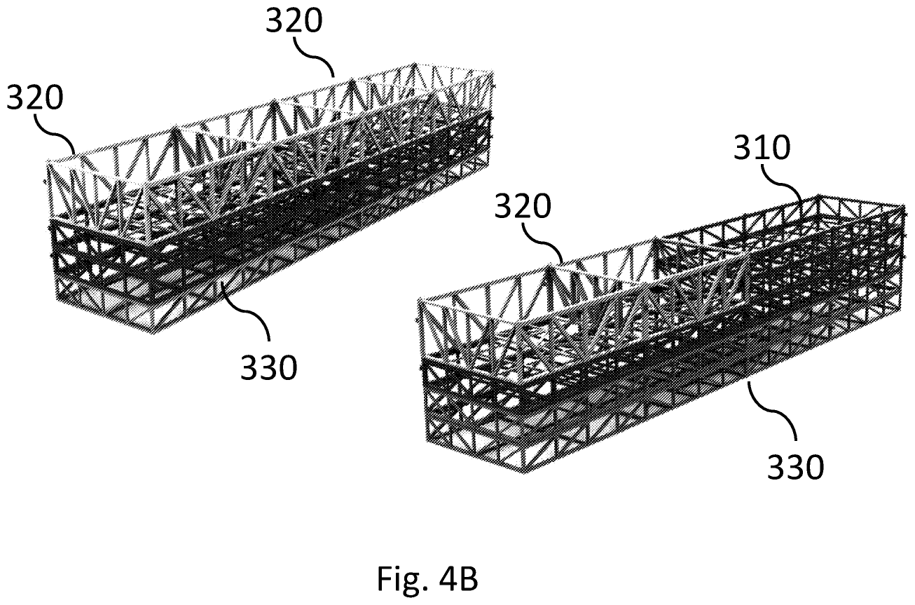

Reference is now made to FIGS. 4A-4B, which illustrate several configurations of assembling the container 310, 320, 330 for cargo transportation, according to some embodiments.

The modular containers may be assembled on top of each other, such that for example two containers of the second configuration 320 shown in FIG. 3B, may be assembled onto a single container of the third configuration 330 shown in FIG. 3C. Similarly, two containers of the first configuration 310 shown in FIG. 3A, may be assembled onto a single container of the second configuration 320 shown in FIG. 3B.

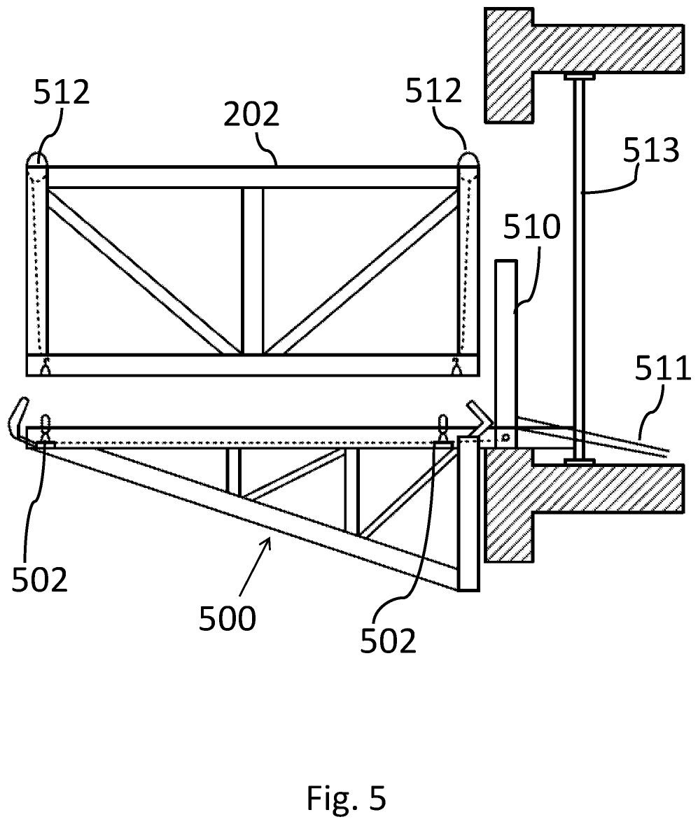

Reference is now made to FIG. 5, which illustrates a side view of an outrigger scaffolding 500 to support the container 202, according to some embodiments.

In some embodiments, at least one wall of the container 202 is configured to be removed and connected to the wall and/or face of a building or structure to create the outrigger scaffolding 500. Thus, the outrigger scaffolding 500 may securely support the container 202 (e.g., placed there by a crane), having dedicated structure and size. In some embodiments, the outrigger scaffolding 500 may also include a dedicated barrier 510 to prevent people from falling.

It should be noted that while a single outrigger scaffolding 500 is shown at the side view in FIG. 5, at least two outrigger scaffoldings 500 may be required to support the bottom portion of container 202.

In some embodiments, the size of the outrigger scaffolding 500 may correspond to the size of the container 202. For example, a twelve meter outrigger scaffolding 500 may be installed to support containers 202 of that size.

According to some embodiments, the outrigger scaffolding 500 connects to the container 202 via at least one pin 502. When the container 202 is placed onto the outrigger scaffolding 500, the at least one pin 502 may be pushed to securely unlock the barrier 510 for access to the container 202. For example, the engagement with the at least one pin 502 may cause a mechanical opening of the barrier 510, an electrical opening of the bather 510 (e.g., after validated QR reading of the container 202) or a hydraulic opening of the barrier 510. In some embodiments, the container 202 includes dedicated pin apertured to engage the at least one pin 502. In some embodiments, once the container 202 is placed onto the outrigger scaffolding 500, the at least one pin 502 may engage an elastic material (e.g., pull a cable) to unlock the barrier 510.

In some embodiments, the barrier 510 is unlocked upon sensor confirmation of a match the container 202 and/or the cargo 20 within.

In some embodiments, the outrigger scaffolding 500 is configured to support additional walls of a container 202. For example, doors, windows, etc. In some embodiments, the container 202 is moved onto the outrigger scaffolding 500 via at least one connector 512 (e.g., lifted by a crane).

In some embodiments, the outrigger scaffolding 500 includes a ramp 511 to allow extraction of the cargo 20 from the container 202 once the barrier 510 is unlocked. In some embodiments, the outrigger scaffolding 500 is further supported by a support rod 513 that may be connected to the roof and/or floor in adjacent to the outrigger scaffolding 500.

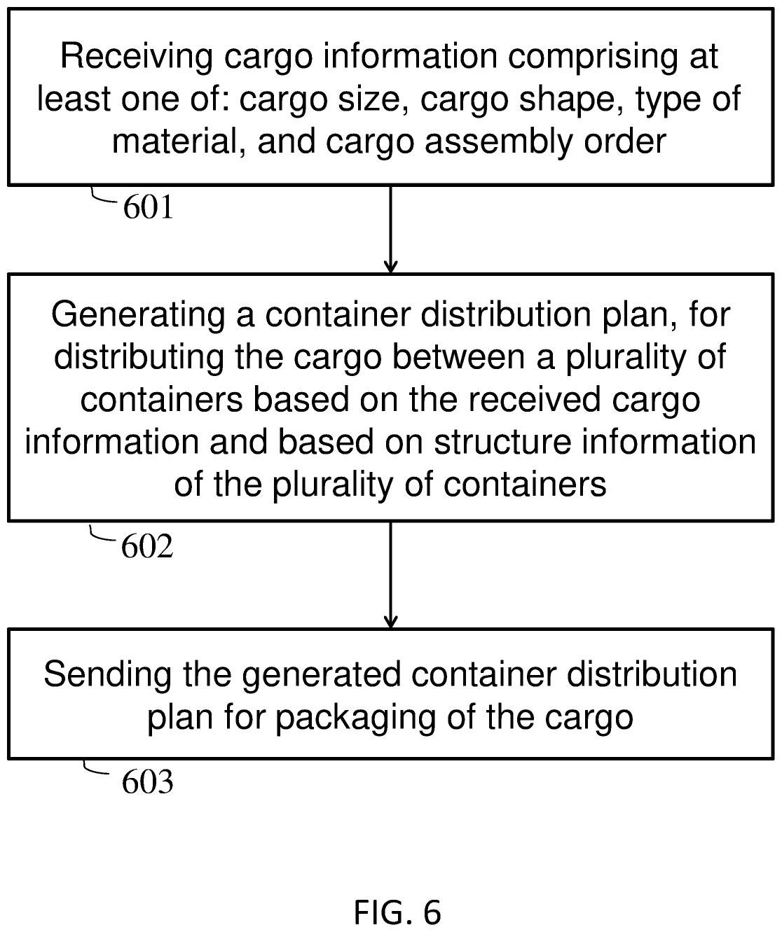

Reference is now made to FIG. 6, which shows a flowchart of a method of managing cargo transportation for a plurality of containers, according to some embodiments.

In Step 601, cargo information may be received (e.g., by the processor), the cargo information including at least one of: cargo size, cargo shape, type of material, and cargo assembly order.

In Step 602, a container distribution plan may be generated (e.g., by the processor), for distributing the cargo between the plurality of containers based on the received cargo information and based on structure information of plurality of containers.

In Step 603, the generated container distribution plan may be sent for packaging of the cargo. For example, the cargo may be packaged at the factory in accordance with the generated container distribution plan.

While certain features of the invention have been illustrated and described herein, many modifications, substitutions, changes, and equivalents may occur to those skilled in the art. It is, therefore, to be understood that the appended claims are intended to cover all such modifications and changes as fall within the invention.

Various embodiments have been presented. Each of these embodiments may, of course, include features from other embodiments presented, and embodiments not specifically described may include various features described herein.

1. A system for cargo transportation management, the system comprising:
a database, to store structure information for a plurality of containers; and
a processor, in communication with the database, wherein the processor is configured to:
receive cargo information, comprising at least one of: cargo size, cargo shape, type of material, and cargo assembly order;
generate a container distribution plan, for distributing the cargo between the plurality of containers based on the structure information and based the received cargo information; and
send the generated container distribution plan for packaging of the cargo.

2. The system of claim 1, wherein the structure information comprises at least one of: capacity, weight, size, shape, center of mass, maximum transportation weight, maximum transportation size, and maximum lifting capacity of a lifting device.

3. The system of claim 1, wherein the plurality of containers comprises modular containers of different sizes.

4. The system of claim 3, wherein the size of at least one container is changeable in accordance with the container distribution plan.

5. The system of claim 1, wherein at least one container of the plurality of containers comprises a sensor to monitor the movement of that container.

6. The system of claim 5, wherein the sensor is selected from a group consisting of: Internet of Things (IoT) sensor, GPS, (INSS, cameras, proximity sensors, weight sensors, accelerometer, gyroscope, barometer, wireless communication module, temperature sensor, and light sensor.

7 (canceled)

8. The system of claim 5, wherein the sensor is in communication with a transport device that is moving the plurality of containers.

9. The system of claim 8, wherein the processor is configured to use input from the sensor in order to optimize location of the plurality of containers adjacent to the transport device.

10. (canceled)

11. The system of claim 1, wherein the generated container distribution plan for packaging of the cargo comprises instructions to assemble the containers with the cargo for transport.

12. The system of claim 1, wherein each container of the plurality of containers is configured to securely lock to at least one other container, at least for the duration of transportation.

13. A method of managing cargo transportation for a plurality of containers, the method comprising:
receiving, by a processor, cargo information comprising t least one of: cargo size, cargo shape, type of material, and cargo assembly order;
generating, by the processor, a container distribution plan, for distributing the cargo between the plurality of containers based on the received cargo information and based on structure information of plurality of containers; and
sending the generated container distribution plan for packaging of the cargo.

14. The method of claim 13, wherein the structure information comprises at least one of: capacity, weight, size, shape, center of mass, maximum transportation weight, maximum transportation size, and maximum lifting capacity by a lifting device.

15. The method of claim 13, further comprising arranging the plurality of containers as modular containers of different sizes.

16. The method of claim 15, further comprising changing the size of at least one container in accordance with the container distribution plan.

17. The method of claim 13, further comprising monitoring movement of each container of the plurality of containers with a sensor.

18. The method of claim 17, wherein the sensor is selected from a group consisting of: Internet of Things (IoT) sensor, GPS, GNSS, cameras, proximity sensors, weight sensors, accelerometer, gyroscope, barometer, wireless communication module, temperature sensor, and light sensor.

19. (canceled)

20. The method of claim 17, wherein the sensor is in communication with a transport device that is moving the plurality of containers.

21. The method of claim 20, wherein the processor is configured to use input from the sensor in order to optimize location of the plurality of containers adjacent to the transport device.

22. (canceled)

23. The method of claim 13, wherein the generated container distribution plan for packaging of the cargo comprises instructions to assemble the containers with the cargo for transport.

24. The method of claim 13, wherein each container of the plurality of containers is configured to securely lock to at least one other container, at least for the duration of transportation.

25. (canceled)

26. (canceled)

27. (canceled)

28. (canceled)
